(19) United States
(12) Patent Application Publication
(10) Pub. No.: US 2006/0101737 A1
(43) Pub. Date: May 18, 2006

(54) Fixing means for laminated glass panes

(76) Inventor: Karl-Otto Platz, WIEHL-BOMIG (DE)

Correspondence Address: Dilier, Ramik & Wight;Merrion Square, Sutie 101, 7345 McWhorter Place, Annandale, VA, 22003, US

(21) Appl. No.: 10/535,659

(22) PCT Filed: Nov. 21, 2003
(86) PCT No.: PCT/EP03/13122

§ 371 Date: May 19, 2005

(30) Foreign Application Priority Data
Nov. 22, 2002 (DE) 202 18 215.0

(51) Int. Cl. E06B 3/00

(52) U.S. Cl. 52/204.5

(57) ABSTRACT

The invention relates to a fixing means for laminated glass panes (2) in statically or dynamically loaded structures, comprising at least one clamping element (4), with which the laminated glass pane (2) can be fixed to a supporting structure (6). According to the invention, the laminated glass pane (2) is comprised of a statically or dynamically loadable supporting glass pane (8) and of at least one covering glass pane (12), which is joined to the supporting glass pane (8) via a casting resin layer (10) and which is provided with electrically conductive transparent conductor paths (14). The at least one clamping element (4) exerts a clamping force, which serves to fix the laminated glass pane (2), only upon the supporting glass pane (8) of the laminated glass pane (2).

The invention refers to a glass structure for statically or dynamically loaded structures, comprising at least one fastening means for at least one laminated glass pane according to the preamble of claim 1.

Such fastening means for laminated glass panes are required in statically or dynamically loaded buildings, the laminated glass panes being fastened by at least one clamping element and a supporting structure.

In statically or dynamically loaded structures, the laminated glass panes are mounted by means of holders or clamping or spot fasteners, respectively. Statically and/or dynamically loaded glass structures are, for example, overhead glazing for roofs, glass walls, facades or all-glass doors. In these cases, the laminated glass pane is pressed against a supporting structure by means of a clamping holder, e.g. designed as a laminar clamping holder or provided in a drill hole. If these laminated glass panes are equipped with an additional cover glass pane, e.g. a cover glass pane provided with electrically conductive, transparent conductor paths, the clamping pressure on the laminated glass pane causes the delamination of the additional cover glass pane. The additional layer makes the overall structure of the laminated glass softer so that the clamping forces for such a laminated glass cannot be calculated exactly, with the result that such laminated glass panes are not allowed for statically and dynamically loaded structures.

It is an object of the invention to provide a glass structure with fastening means for laminated glass panes that allows for a reliable fastening of the laminated glass pane in statically and dynamically loaded structures, even if an additional cover glass pane is used.

The object is solved with the features of claim 1.

The invention advantageously provides that the laminated glass pane comprises a statically and dynamically loadable supporting glass pane and at least one cover glass pane connected with the supporting glass pane by means of a layer of cast resin, the cover glass pane being provided with electrically conductive transparent conductor paths, wherein the at least one clamping element exerts a clamping force for fastening the laminated glass pane only on the supporting glass pane of the laminated glass pane.

In principle, a glass structure is selected as the supporting glass pane, which is officially approved, e.g. a hardened single pane in case of an all-glass door, or a laminated glass in PVB foil with hardened or non-hardened single panes, e.g. in fall-safe glazing and overhead glazing.

Using cast resin, a cover glass pane with electrically conductive, transparent conductor paths is adhered onto this supporting glass pane.

The fastening means is a clamping element that exerts its fastening force only on the supporting glass pane of the laminated glass pane. Thus, the clamping force of the clamping elements cannot cause the delamination of the cover glass pane from the laminate of panes.

The clamping force of the clamping elements can be calculated exactly so that such laminated glass panes can also be employed with statically and dynamically loaded glass structures.

Preferably, the clamping elements comprise a flange portion adapted to engage behind the supporting glass pane in order to press the entire laminated glass pane against a supporting structure, e.g. a post/crossbar structure or other supporting elements.

The clamping elements may be passed through a recess in the supporting glass pane. Preferably, the recess is a hole, yet, depending on the design of the clamping element, it may also be of any other shape adapted to the clamping element. Even in the periphery of the laminated glass pane, the recess does not necessarily have to be a hole.

It is provided in one embodiment that the clamping elements are integrated in the laminated glass pane, wherein the cover glass pane covers the entire surface of the laminated glass pane. Thus, the cover glass pane covers the recesses in the supporting glass pane with the clamping elements therein and seals the entire laminated glass pane to the outside. This is particularly advantageous if the laminated glass pane is used in wet areas, e.g. shower cabins, in humid areas or in outside areas, e.g. roof structures. Due to the sealing of the laminated glass pane, no humidity can reach the electrically conductive conductor paths and the current loads.

In the peripheral portion of the laminated glass pane it may be provided that the cover glass pane recedes with respect to the supporting glass pane so that the at least one clamping element can engage behind the supporting glass pane.

As an alternative, in the peripheral region of the laminated glass pane, the cover glass pane may merely be recessed in the area of the clamping elements.

In another embodiment it is provided that the clamping elements are passed through the entire laminated glass pane, the cover glass pane having larger recesses as compared to the recesses in the supporting glass pane so that the clamping elements adapted to be inserted through both recesses can only engage behind the supporting glass pane.

It is provided in one embodiment that the clamping elements terminate flush with the cover glass pane on the outer side thereof. In this manner, the laminated glass pane shows a smooth outer surface, the gap between the clamping elements and the cover glass pane possibly being filled with plastic material. Thus, a sealing of the laminated glass pane at the fastening points is achieved as well.

The current loads may be a plurality of light emitting diodes emitting light to one or both sides.

The clamping elements may also be used to supply current to the electrically conductive conductor paths of the cover glass pane. For this purpose, the clamping elements comprise current connection elements that are connected to the electrically conductive transparent conductive paths of the cover glass pane. At their outer edges or recess edges, the cover glass panes comprise corresponding current connections of the electrically conductive layers.

The clamping element may have a single current connection or it may be comprised of a plurality of mutually insulated segments that may supply current or control signals to a plurality of current connection elements.

The following is a detailed description of embodiments of the invention with reference to the drawings.

In the Figures:

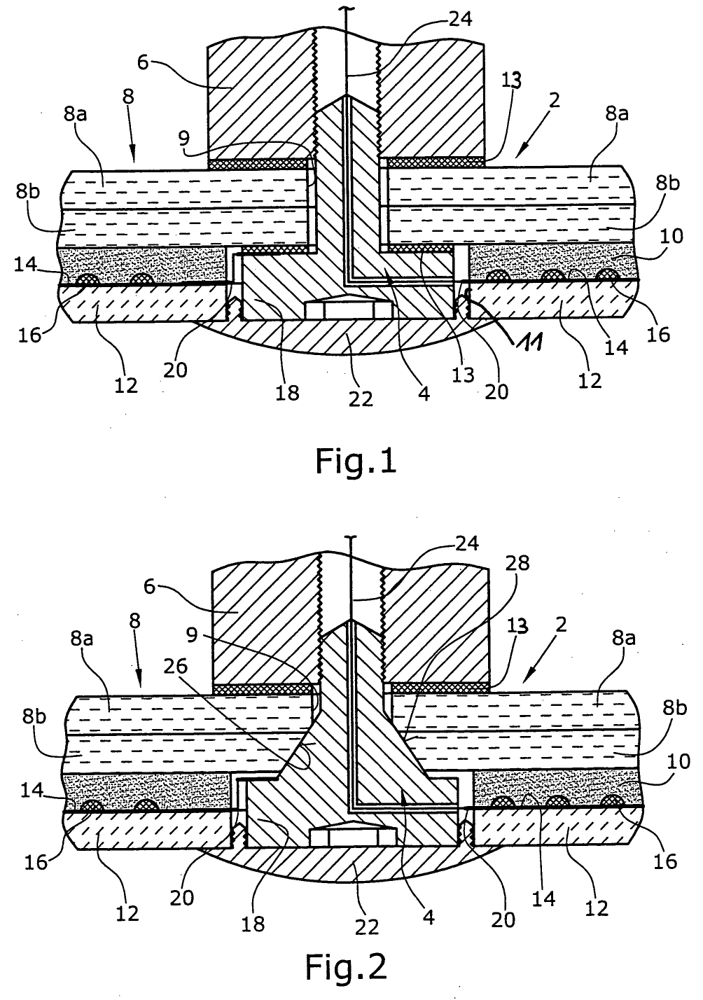

FIG. 1 illustrates a first embodiment with a clamping element seated in a stepped hole in the laminated glass pane,

FIG. 2 illustrates a second embodiment with a conical clamping element,

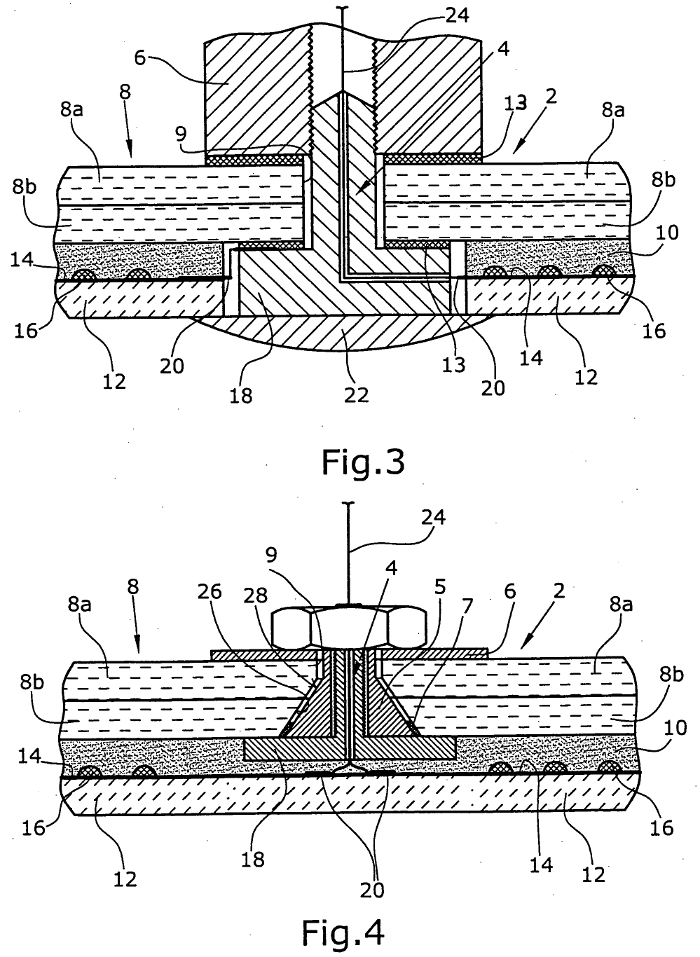

FIG. 3 shows a clamping element according to the present invention between two adjoining laminated glass panes,

FIG. 4 illustrates another embodiment with the clamping elements being integrated in the laminated glass pane, and

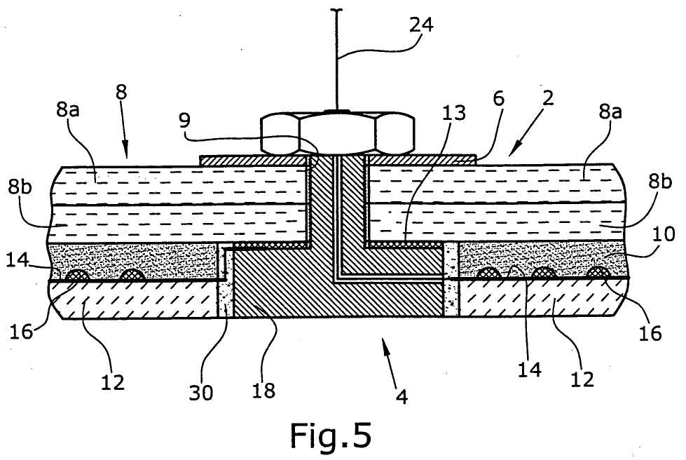

FIG. 5 shows another embodiment of the clamping element flush with the outer surface of the laminated glass pane.

The embodiment of FIG. 1 shows a laminated glass pane 2, comprising a supporting glass pane 8 and a cover glass pane 12 adhered to the supporting glass pane 8 through a layer of cast resin 10.

The supporting glass pane is a laminated composite glass in PVB foil with hardened or non-hardened single panes 8a, 8b.

The cover glass pane is made of normal or hardened float glass and includes transparent electrically conductive conductor paths 14 that may be produced with an ITO coating, for example. The conductor paths 14 are connected to electric loads 16, e.g. LEDs emitting light to one or both sides.

The cover glass plate 12 may also be made of a hardened or non-hardened single pane or of a laminated composite glass that may also be hardened or not.

The supporting glass pane 8 is type-tested and has an official approval for use in statically and dynamically loaded structures. This is important, for example, with overhead glazings and fall-safe glazings of parapet elements, but also with all-glass doors.

The cover glass pane 12 is adhered onto such officially approved supporting glass panes 8 using the layer of cast resin 10, wherein, at the fastening points for the laminated glass 8, the cover glass 12 recedes so far from the supporting glass that the fastening means exerts its clamping force only on the supporting glass 8. The offset of the glass edge is used at the same time to lead out from the cover glass pane 12 a connecting cable for the current supply.

In the embodiment of FIG. 1, the edge offset is a stepped hole, a recess 9 being provided in the supporting glass pane 8 and a recess 11 being provided in the cover glass pane 12.

The recess 11 in the cover glass pane and in the associated layer of cast resin 10 has a larger diameter than the recess 9 so that the fastening means formed by a clamping element 4 rests only on the supporting glass pane 8 and exerts forces only on the supporting glass pane 8.

The clamping element 4 clamps the laminated glass pane 2 against a supporting structure 6, e.g. a post or a post/crossbar structure. For reasons of simplification, the clamping element 4 is illustrated as a screw connection, the clamping element 4 being adapted to be screwed into the supporting structure 6 by means of a hexagon socket on the outer side and a thread portion at the end opposite the hexagon socket, whereby the clamping element exerts the clamping force on the supporting glass pane 8. Seals 13 may be provided between the supporting structure 6 and the supporting glass pane 8 as well as between the supporting glass pane 8 and the clamping element 4. However, it is also possible to clamp the flange portion 18 of the clamping element 4 directly against the supporting glass pane 8.

Current may be supplied to the conductor paths 14 through the clamping element 4 via a single wire or a multi-wire cable, so as to supply current to the electric loads 16.

The clamping element 4 itself, e.g. in the form of a screw, can be used as a current conductor, e.g. for connection to ground, the clamping element 4, as obvious on the left in FIGS. 1 and 2, for example, being electrically connected with the conductor paths 14, e.g. the negative terminals, at a connecting point 20. At the right, for instance, the positive terminal is supplied at a further connecting point.

With a multi-wire cable, different conductor paths 14 may be supplied with current.

FIGS. 1 and 2 illustrate a cover element 22 adapted to the inserted into the recess 11 in the cover glass pane 12 to hide the clamping element 4.

As an alternative, the cover element 22 may also be fixed to the clamping element 4 or be formed integrally therewith, as illustrated in FIG. 3.

FIG. 3 further differs from the embodiment of FIG. 1 in that two adjoining laminated glass panes 2 are fastened to the supporting structure 6 using the clamping element 4. In this case, only the cover glass element 12 with the layer of cast resin 10 is recessed to receive the clamping element 4.

FIG. 4 illustrates another embodiment of the invention, wherein the clamping element 4 is integrated in the laminated glass pane 2. In this case, the cover glass pane 12 is continuous and the flange portion 18 of the clamping element 4 is embedded into the layer of cast resin 10.

The supporting glass pane 8 is recessed corresponding to the clamping element 4, wherein the clamping element 4 may be a single part or, as illustrated in FIG. 4, a multi-part element.

Again, it is guaranteed that the clamping element 4 exerts the clamping force only on the supporting glass pane 8.

The clamping element 4 may again be provided with a channel for current lines 24.

The clamping element 4 may be of conical design shaped as a conical portion 28, the recess in the supporting glass pane 8 having a portion bevelled corresponding to the conical portion 28.

Different from the embodiments of FIGS. 1 to 3, the supporting structure 6 is not a post/crossbar structure, but is made up of a flat supporting structure, the clamping element 4 being adapted to be screwed to the supporting structure using a fastening screw.

The supporting glass pane 8 is mounted first with the clamping element 4 and the cover glass pane 12 is then applied using the layer of cast resin 10. It is an essential advantage of such a laminated glass pane 2 that no water can reach the electrically conductive conductor paths 14 since entire surface of the laminated glass pane 2 is covered by the cover glass pane 12.

FIG. 5 illustrates another embodiment similar to the embodiment of FIG. 1, the clamping element 4 terminating flush with the cover glass pane 12. A sealant 30 is injected into the recess 11 between the clamping element 4 and the cover glass pane 12 or the layer of cast resin 10, respectively, which sealant is also flush with the cover glass pane 12 and the clamping element 4. The fastening to the supporting structure 6 corresponds to that of FIG. 4.

What is claimed is:

1-18. (canceled)

19. A glass structure for statically or dynamically loaded structures comprising at least one laminated glass pane (2) and at least one clamping element (4) by which the laminated glass pane (2) can be fastened to a supporting structure (6), wherein the laminated glass pane (2) comprises a statically and dynamically loadable supporting glass pane (8) and at least one cover glass pane (12) connected with the supporting glass pane (8) through a layer of cast resin (10), the cover glass pane being provided with electrically conductive transparent conductor paths (14), the clamping force for fastening the laminated glass pane (2) being exerted by the at least one clamping element (4) only on the supporting glass pane (8) of the laminated glass pane (2).

20. The glass structure as defined in claim 19 wherein the supporting glass pane (8) is a hardened single glass pane.

21. The glass structure as defined in claim 19 wherein the supporting glass pane (8) is a composite glass laminate in PVB foil with a plurality of hardened or non-hardened single panes (8a, 8b).

22. The glass structure as defined in claim 19 wherein the cover glass pane (12) comprises current loads (16) connected to the electrically conductive transparent conductor paths (14).

23. The glass structure as defined in claim 19 wherein the at least one clamping element (4) has a flange portion (18) engaging behind the supporting glass pane (8).

24. The glass structure as defined in claim 19 wherein each clamping element (4) is passed through a recess (9) in the supporting glass pane (8).

25. The glass structure as defined in claim 24 wherein the at least one clamping element (4) is integrated in the laminated glass pane (2), the cover glass pane (12) covering the entire surface of the laminated glass pane (2).

26. The glass structure as defined in claim 19 wherein the clamping element (4) holds the supporting glass pane (8) in an edge portion in which the cover glass pane (12) recedes from the supporting glass pane (8).

27. The glass structure as defined in claim 19 wherein only the cover glass pane (12) is recessed in the edge portion of the laminated glass pane (2) in the area of the clamping elements (4).

28. The glass structure as defined in claim 24 wherein the cover glass pane (12) has a larger recess (11) relative to the recess (9) and the clamping elements (4) adapted to be inserted through both recesses (9, 11) hold the supporting glass pane (8).

29. The glass structure as defined in claim 28 wherein the clamping elements (4) terminate flush with the cover pane (12).

30. The glass structure as defined in claim 28 wherein the gap between the clamping element (4) and the cover glass pane (12) is sealed with plastic material.

31. The glass structure as defined in claim 29 wherein the gap between the clamping element (4) and the cover glass pane (12) is sealed with plastic material.

32. The glass structure as defined in claim 22 wherein the current load (16) is a plurality of light emitting diodes emitting light to one or both sides.

33. The glass structure as defined in claim 19 wherein the at least one clamping element (4) comprises current connection elements (20) for current supply to the electrically conductive conductor paths (14) of the cover glass pane (12).

34. The glass structure as defined in claim 33 wherein the current connection elements (20) protrude from the portion of the clamping element (4) facing the cover glass pane (12).

35. The glass structure as defined in claim 19 wherein the clamping element (4) comprises a plurality of mutually insulated segments supplying a plurality of current connection elements (20) with current or control signals.

36. The glass structure as defined in claim 19 wherein the clamping element (4) comprises a screw thread for fastening to the supporting structure (6).

37. The glass structure as defined in claim 24 wherein the at least one recess (9) in the supporting glass pane (8) comprises a beveled portion (26) adapted to a conical portion (28) of the clamping element (4).
